(19) United States
(12) Patent Application Publication
(10) Pub. No.: US 2007/0071354 A1
(43) Pub. Date: Mar. 29, 2007

(54) Medical imaging system with temporal filter

(76) Inventors: Raoul Florent, Ville D'Avray (FR); Christophe Samson, Paris (FR); Mathieu Picard, Paris (FR)

Correspondence Address: PHILIPS INTELLECTUAL PROPERTY & STANDARDS, P.O. BOX 3001, BRIARCLIFF MANOR, NY, 10510, US

(21) Appl. No.: 10/572,616

(22) PCT Filed: Sep. 2, 2004
(86) PCT No.: PCT/IB04/02891

§ 371 Date: Oct. 18, 2006

(30) Foreign Application Priority Data
Sep. 22, 2003 (EP) 03300128.0

(51) Int. Cl. G06K 9/40

(52) U.S. Cl. 382/266; 382/265

(57) ABSTRACT

The invention relates to an image processing system for reduction of the noise and enhancement of edges in images of a sequence, comprising means of decomposition of spatial image signal yielding slices of different content; means of temporal filtering for differently filtering the slices according to the content; and means of recomposition of the images of the sequence from the temporally filtered slices. The decomposition may be performed using means of pyramidal decomposition. The means of temporal filtering may comprise motion compensation and/or recursive adaptive filtering. This system may further comprise imaging means for displaying the images of the sequence. The invention further relates to a medical examination apparatus coupled to this system.

### FIELD OF THE INVENTION

The invention relates to a medical imaging system for the processing of an image in a sequence of noisy images that includes means for the temporal filtering of the noise. The invention also relates to a medical examination apparatus that includes such a system. The invention can be used for the manufacture of medical X-ray examination apparatus.

### BACKGROUND OF THE INVENTION

A medical imaging system having means for temporal filtering of noise in a sequence of images is already described in the U.S. Pat. No. 6,151,417. This system comprises means for filtering the noise in a sequence of images representing very thin objects, such as catheters or optical fibers, without excluding image parts representing such very thin objects in motion. This system comprises means for the processing of an image in a sequence of noisy images which includes means for extracting a noisy temporal sample at a given location in the noisy image and for supplying a corresponding, temporary filtered sample for the formation of a noise-filtered image. Said system includes:

temporal filtering of an image in a temporal sequence from a set of past (and eventually future) frames. The temporal filter includes an adaptive process which modulates the filtering power with respect to content of the frame sequence (high or low motion, high or low noise level).

two-dimensional spatial filtering means, which are applied to said difference image in order to enhance spatially coherent samples and to supply a measure of probability of motion which is linked to said spatially coherent samples, The known system can operate in real time. It can apply the temporal filtering to the image parts with and without an object in motion in order that the edges of the object are not blurred and the very small objects in motion are not lost. The noise peaks are reduced.

At least two problems are encountered in the known system:

1) A first problem relates to noisy images representing objects with sharp interfaces in movement. In such images processed by the known system, noise tails are present. This is due to the fact that the proposed filter adapts itself to the temporal discontinuity near the moving interface or moving edge. When a temporal discontinuity is detected, the filter reacts in minimizing its power of temporal integration. This results in a noise break-through. This defect is particularly drastic in the case of sharp edges. It can be attenuated by motion estimation and motion compensation. But this compensation is never perfect.

2) A second problem relates to noisy images representing moving objects with slowly spatially varying zones, such as background zones in motion. The temporal filter has for an object to estimate temporal discontinuities. Since such slowly spatially varying zones in motion present very small temporal contrast values, they generate low temporal gradients and they may be mistaken for noise. In this case, the filter power is high, which results in unwanted smoothing of the slowly varying zones. The processed images present traces in front of and behind the objects located in the considered zones. Besides, said smoothed objects are blurred by the temporal filtering process. This situation can also appear in the case when the intensity varies slowly in the time of the sequence producing a slow variation of the intensity gradients.

### SUMMARY OF THE INVENTION

The present invention has for an object to propose an image processing system, having means for overcoming the above-described drawbacks. In particular, the system according to the invention has processing means for: acquisition of a sequence of digital images; decompose each image of the temporal sequence into sub-image signals called slices, each slice being representative of a distinct spatial frequency band; individual temporal filtering of each slice; reconstruction of the images from the temporally filtered slices. For instance, the signal decomposition can be achieved by the use of well known Laplacian or Gaussian pyramids, resulting for each decomposed image to a set of slices of different resolution. The temporal filtering of the slices may be performed with adaptive filters, which may have motion compensation and/or which may be recursive adaptive filters.

The invention further relates to an image viewing system for enhancing objects of interest represented in a sequence of noisy images and for displaying the sequence of enhanced images. The invention also relates to a computer executable image processing method to be used in said system. The invention further relates to a medical examination apparatus coupled to such a system. This apparatus offers the advantage that it supplies better images, particularly in the case where the illumination intensity of the object whose image is formed is low; it nevertheless enables an operator to track very thin objects in motion accurately during display of the sequence of images. The invention finds for example its application in the medical field of cardiology, for enhancing thin moving objects of interest such as catheters or guidewires while filtering the electronic noise.

### BRIEF DESCRIPTION OF THE FIGURES

Embodiments of the invention are described hereafter in detail in reference to diagrammatic figures wherein:

FIG. 1 is a functional block diagram of means of the system of the invention;

FIG. 2 is a more detailed functional block diagram of means of the system of the invention illustrating the temporal filtering within a multi-resolution scheme;

FIG. 3 illustrates the signal spectrum slicing in case of a Laplacian pyramid decomposition;

FIG. 4 illustrates the image decomposition of FIG. 2;

FIG. 5 is a functional block diagram of a medical examination apparatus using the system of the invention.

### DESCRIPTION OF EMBODIMENTS

The invention relates to a viewing system and particularly to a medical imaging system, and to an image processing method that is used in the viewing system, for enhancing objects of interest in a sequence of noisy images and for displaying the sequence of enhanced images. The viewing system and method have means to acquire, process and display the images in real time. The viewing system and the image processing method of the invention are described hereafter as a matter of example in an application to the medical field of cardiology. In said application, the object of interest is for example a catheter. This object is observed during a medical intervention called angioplasty, in a sequence of X-ray images. The system and method may be applied to any other objects of interest than catheters. The objects of interest may be moving with respect to the image referential; and the background may be moving with respect to the objects or to the organs.

Adaptive Temporal Recursive filtering (ATR) is a key technique when dealing with noise reduction, in particular in the field of medical imaging. This technique might apply whenever image sequences are available, and whenever the images of those sequences are corrupted with a noise that is fairly uncorrelated along the time axis, which is most often the case. The basic principle of ATR filtering consists, for each pixel, in building a weighted average of the values of a set of pixels located at the same spatial position in the image, but belonging to different images along the time axis. Since the corrupting noise is fairly uncorrelated along this axis, the outcome of this averaging operation will be the reduction of the noise level in the resulting images. Usually, this weighted averaging operation is realized with a recursive filter.

In order to preserve the signal, the natural or apparent motions of the considered objects must be dealt with. For example, the imaging system may have means to perform an adaptation of the integration coefficients of the temporal recursive filter as a function of the observed temporal discontinuity at each pixel. Thus, for a given pixel, if the temporal discontinuity is well above the noise level, then motion is diagnosed and the filtering at this pixel location is decreased, down to full cancellation if necessary. On the contrary, if the motion discontinuity is of the same order of magnitude as the noise level, then filtering is applied up to a maximum level when there is certainty about the absence of motion at that pixel location.

However, there are at least two drawbacks to this technique.

On the one hand, near the edges of moving objects in the images, called moving edges, the filter naturally switches off, which leads to the positive effect of edge preservation, but which also entails a local noise breakthrough near those edges.

On the other hand, if there are large slowly moving and slowly-spatially-varying background masses, then they might produce only slight temporal discontinuities, no more than the noise level. In that case, those large masses will be temporally integrated, thus creating a somewhat artificial looking.

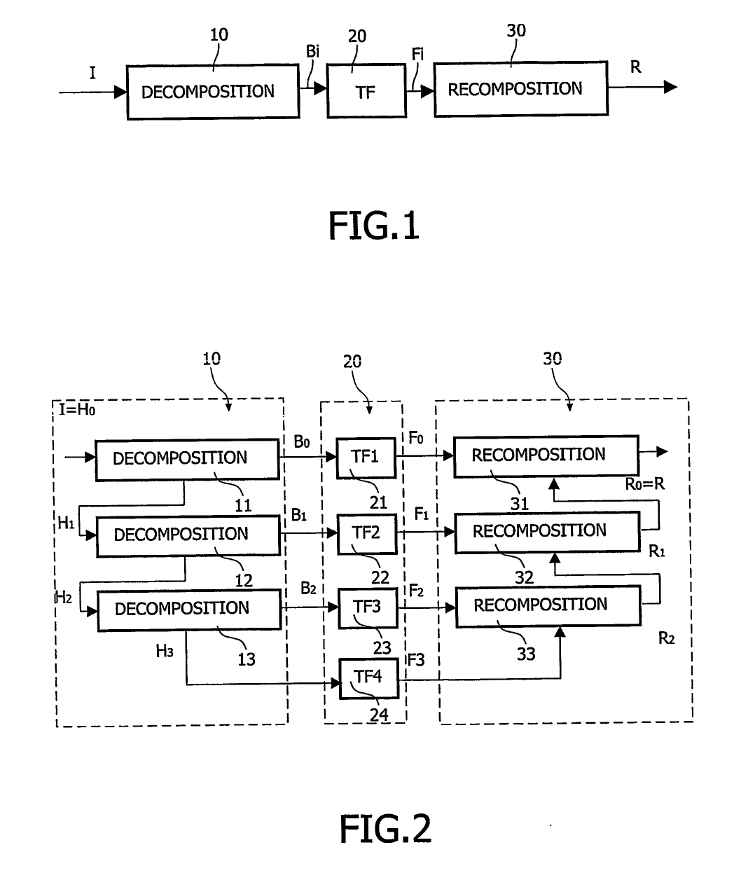

The present invention proposes an image processing system, having means for overcoming both these drawbacks. Referring to FIG. 1, this system comprises:

1) Decomposition means 10 for slicing the spectrum of image I of the considered sequence in several sub-images, called slices, for instance using the well known Laplacian or Gaussian multi-resolution pyramid decomposition;

2) Filtering means 20 for temporally filtering all the sub-bands or slices of the pyramid that are related to high frequencies when using a Laplacian pyramid for instance, but leaving intact the low frequencies. This leads to the application of several temporal filters in parallel on the different slices. Each of the temporal filters is separately tuned and this tuning is adapted to the spectral content of the input image and its related slices. In a preferred embodiment the system has means for applying an Adaptive Temporal Recursive filter (ATR) on all the sub-bands of the pyramid, while leaving intact the low frequencies.

3) Recomposition means 30 for recomposing the result image R from the low frequencies, and from the filtered sub-bands.

The system of the invention solves the two problems. On the one hand, this system is able to keep intact the low frequencies, which enables the preservation of the slowly-spatially-varying background masses, since they are mainly located in the low-frequency part of the spectrum. On the other-hand, as this system has means to apply distinct ATR filters in the other sub-bands, this system allows to filter those edge pixels that produce, in some sub-bands of the spectrum, low temporal variations.

Referring to FIG. 2, according to the invention, the imaging system comprises more particularly:

1) Processing means 10 for performing the sub-sampling, called decomposition, of the image I of a sequence of images. These processing means yield a number N of sub-sampled images. For instance, for a Laplacian decomposition, this leads to the sub-sampled images called sub-bands or slices Bi (i=0, . . . , N−1), and low resolution slices Hi (i=0, . . . , N) for each image of the sequence.

Temporal filtering means, preferably adaptive temporal recursive (ATR) filters 20, which receive the sub-samples Bi and the low-resolution sub-image H_{N}, yielding to the temporally filtered sub-samples Fi and F_{N}.

Processing means 30 for performing a recomposition operation, from the temporally filtered sub-samples Fi, yielding a filtered image signal R.

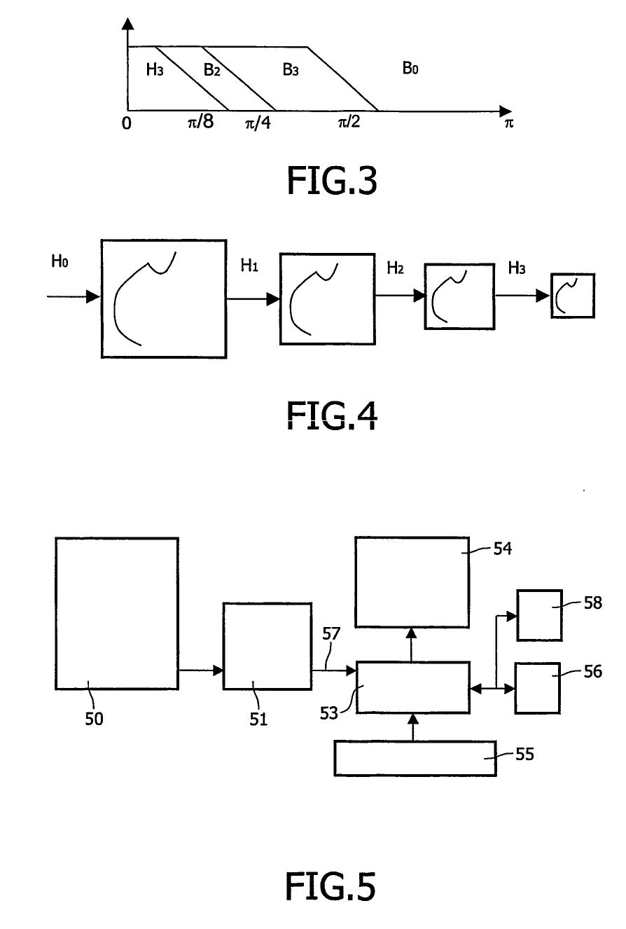

Referring to FIG. 2, the decomposition means 10 may comprise Laplacian or a Gaussian multi-resolution pyramid decomposition stages. In the case of a Laplacian decomposition, this leads to the spectrum decomposition of input image I as illustrated on FIG. 3.

FIG. 4 illustrates a decomposition of an image I of the sequence into four sub-images at different resolutions.

The decomposition means of the example illustrated by FIG. 2 comprises three decomposition modules 11, 12, 13, which yields three sub-bands B₀, B₁, B₂ (in decreasing resolution), and a slice H₃, in a low frequency band that may be kept intact.

The analysis or decomposition is performed for each image of the sequence.

2) Filtering means 20 comprising several filtering modules 21, 22, 23, 24, each module being applied to each corresponding sub-bands or slices B₀, B₁, B₂ and (eventually) to low-resolution H₃. The temporal filters of these modules may be identical or different. They are characterized by parameters for controlling their power of integration. These several temporal filters are intended to highly filter the sub-bands in the highest frequencies and to lowly filter the sub-bands in the lowest frequencies.

Since the different slices are filtered individually, this ensemble of filters solves the two problems exposed above. The module 24 applied to the low-frequency sub-band may be feebly active or inactive in order to preserve the low frequencies. Instead, the high frequencies in sub-band B₀ may be strongly filtered.

3) Processing means 30 for performing the recomposition of the images of the sequence. In the result R of the recomposition of each image, the low frequencies are intact or only feebly temporally filtered, which solves the second problem exposed above. Instead in this result R, the high frequencies are strongly filtered, which solves the first problem exposed above.

The slices may be small and numerous or large and only a few. The contribution may be different from one slice to another, and particularly, which is greater in the highest frequencies. As a matter of fact, the high frequencies are characterized by sharp edges with neat movements. Hence, it is favorable to use the strongest filtering in the highest frequencies.

Consider for example a sequence of images composed of object such as a cross-section of a vessel. The walls are edges in movement under the blood pressure. The walls are represented in the slices of high frequencies and will be strongly temporally filtered. The lumen is in a slice of low frequency and will be either not filtered or feebly temporally filtered. The recomposed image will be improved at best. This could not be the case while using the system of the prior art since the high frequency walls and the low frequency lumen would have been filtered in the same manner.

Regarding a spatial discontinuity in motion, this discontinuity may not be distributed uniformly in the slices. The temporal discontinuity may be different from one slice to another. The system of temporal filters of the invention permits of solving this disparity.

The temporal filters of the module 20 may be for example as described in the U.S. Pat. No. 6,151,417. Other temporal filters not described may be used. The temporal filters may be recursive and may include compensation means for compensating motion and for registration. This patent describes a function f, which controls the strength of integration. The height of the function gives the power of integration, the slope defines the fuzziness, and the cut abscissa specifies the separation point between noise and motion. These parameters may be adapted for each slice.

FIG. 5 shows a diagram of a medical examination apparatus 50. The apparatus has means 51 for acquiring digital image data of a sequence of images, and is coupled to a medical viewing system 53 as described above, for processing these data according to the processing technique cited above. The medical viewing system is generally used in the intervention room or near the intervention room for processing real time images. Should steps of the present method be applied on stored medical images, for example for estimating medical parameters, the system for processing the data of the stored images would be called medical viewing station. The medical examination apparatus provides the image data by connection 57 to the system 53. The system provides processed image data to display means and/or storage means. The display means 54 may be a screen. The storage means may be a memory of the system 53. Said shortage means may be alternately external storage means. This image viewing system 53 may comprise a suitably programmed computer, or a special purpose processor having circuit means such as LUTs, Memories, Filters, Logic Operators, that are arranged to perform the functions of the method steps according to the invention. The system 53 may also comprise a keyboard 55 and a mouse 56. Icones may be provided on the screen to be activated by mouse-clicks, or special pushbuttons may be provided on the system, to constitute control means 58 for the user to start, to control the duration or to stop the processing means of the system at chosen phases.

1. An image processing system for reduction of the noise and enhancement of edges in images of a sequence, comprising:
means of decomposition of spatial image signal yielding slices of different content;
means of temporal filtering for differently filtering the slices according to the content;
means of recomposition of the images of the sequence from the temporally filtered slices.

2. The system of claim 1 wherein the decomposition is performed using means of pyramidal decomposition.

3. The system of claim 1 wherein the means of temporal filtering comprises adaptive filtering.

4. The system of claim 1 wherein the means of temporal filtering comprises motion compensation.

5. The system of claim 1 wherein the means of temporal filtering comprises recursive adaptive filtering.

6. The system of claim 1, further comprising imaging means for displaying the images of the sequence.

7. An imaging apparatus comprising a suitably programmed computer or a special purpose processor having circuit means, which are arranged to process images, to be used in a system as claimed in claim 1.

8. A computer program product comprising a set of instructions for carrying out an image processing to be used in a system as claimed in claim 1.

9. A medical examination imaging apparatus having means for acquiring a sequence of medical images and having a viewing system for processing and for displaying said sequence of images according to claim 1.
